(19) United States
(12) Patent Application Publication
(10) Pub. No.: US 2025/0327356 A1
(43) Pub. Date: Oct. 23, 2025

(54) LAMINATED PANE COMPRISING AN ELECTRICAL ELEMENT

(71) Applicant: Pilkington Group Limited, Lathom (GB)

(72) Inventors: Christian EIBL, Duisburg (DE); Marcel RIBBERINK, Enschede (NL); Christoph HAYN, Ratingen (DE)

(21) Appl. No.: 18/864,608

(22) PCT Filed: May 17, 2023
(86) PCT No.: PCT/GB2023/051302

§ 371 Date: Nov. 11, 2024

(30) Foreign Application Priority Data
May 19, 2022 (GB) 2207366.2

(51) Int. Cl. E06B 7/28; E06B 3/663

(52) U.S. Cl. CPC E06B 7/28; E06B 3/66319

(57) ABSTRACT

A laminated panes suitable for installation in a building, façade or architectural barrier, includes an electrical carrier adhered directly or indirectly to the first major face of a sheet of glazing material and in electrical communication, with an electrical element between the first sheet of glazing material and a second sheet of glazing material. This provides the advantages that the electrical carrier is less likely to be snagged or lost while allowing connection of electrical elements within laminated panes using means suitable for connection to electrical elements within insulated glazing cavities, such as spacer frame sections with integrated connections.

The present invention relates to laminated panes, in particular a laminated pane comprising an electrical element, a method of manufacturing such a laminated pane, and an insulated glazing comprising such a laminated pane.

Insulated glazings are commonly installed into apertures in buildings: such apertures may be in the building envelope or within the building itself. An insulated glazing commonly comprises at least two glazing panes arranged in a face-to-face configuration with a cavity therebetween. A common glazing pane for insulated glazings is a glass sheet. The cavity is generally maintained by a frame between the glazing panes, and often the cavity comprises an insulating gas, but in some cases the cavity may comprise a vacuum. In either case, a hermetic seal is often provided around the periphery and between the sheets of glazing material to preserve the atmosphere of the cavity. The hermetic seal is provided by the spacer frame and/or secondary sealants.

In some cases the glazing panes of insulated glazings are laminated panes. Laminated panes typically comprise two or more sheets of glazing material, often glass, adhered together by an interlayer, commonly polyvinyl butyral. Such laminated panes may be employed to improve heat insulating performance, sound insulating performance, and/or intrusion resistance, for example.

Alternatively, such laminated panes may be used without incorporation into an insulating glazing, known as a monolithic construction. Laminated panes may be used in a monolithic construction where heat insulating performance is not a concern, for example in architectural barriers, such as road-side acoustic barriers and balconies, and in internal glazings such as dividers.

In some cases, laminated panes may comprise electrical elements between the sheets of glazing material which require the supply of electrical energy and/or data from outside the laminated pane. Such electrical elements may include heating coatings, displays, transducers, light emitters, sound emitters, sensors and the like. For example WO 2017027407 A1 discloses electrochromic device integrated glazing unit constructions.

Previous methods of supplying electrical energy to electrical elements between laminated sheets of glazing material have included wires protruding from between the sheets of glazing material. However, such wires are easily snagged during production, transport and/or installation, which may degrade or even completely prevent electrical communication with the electrical element.

Therefore, alternative connection methods have been investigated.

For example WO 2019086340 A1 discloses an integrated glazing unit (IGU), comprising: (a) a first pane comprising a first pane edge; (b) an electronic laminate comprising:—a first substrate—a second substrate, —an electronic device provided between the first and second substrate, a plurality of terminals coupled to the electronic device, —a laminate edge recessed with respect to the first pane edge; and wherein the first substrate is attached to the first pane; (c) a flexible circuit board electrically coupled to at least a portion of the plurality of terminals and comprising an extended portion protruding out of the laminate edge and comprising a free end; (d) a second pane comprising a second pane edge and attached to a spacer of height H measured normal to the second pane, maintaining a distance between the second pane and the second substrate, said spacer being recessed with respect to the laminate edge and the second pane edge; wherein the extended portion of the flexible circuit board is flush with or recessed from the second pane edge, and wherein the free end is located within a coupling volume. Said coupling volume has a rectangular cross-section normal to the second pane edge and a height H, and is defined by the second pane and the spacer.

However, the integrated glazing unit of WO 2019086340 A1 requires the spacer of the insulated glazing unit to be further in from the edge of the insulated glazing than commonly is the case, resulting in a reduced viewing area of the insulated glazing. Furthermore, the process requires multiple steps, which increases processing costs. In addition, the disclosed embodiments are not suitable for monolithic constructions.

Therefore, there remains a need for a laminated pane comprising an electrical element which may be efficiently produced, that is suitable for monolithic constructions and insulated glazing units, and that comprises a robust and secure electrical connection means.

According to the first aspect of the invention there is provided a laminated pane suitable for installation in a building, façade or architectural barrier, comprising:
a first sheet of glazing material comprising a first major face, a second major face and an edge face;
a second sheet of glazing material comprising a third major face, a fourth face and an edge face;
an adhesive layer between the second face and the third face;
an electrical element between the first sheet of glazing material and the second sheet of glazing material; and
an electrical carrier adhered directly or indirectly to the first major face and in electrical communication, preferably direct electrical communication, with the electrical element.

An electrical carrier which is adhered directly or indirectly to the first major face and the second major face is particularly advantageous, as it is less likely to be snagged or lost.

In addition, an electrical carrier which is adhered directly or indirectly to the first major face and the second major face may be readily employed with simple connection means which would be used when an electrical element is associated with the first major face of a laminated pane. As such, conventional frames may be used that do not require drilling, routing, or other costly processing by fabricators to allow connection to electrical elements.

Furthermore such an electrical carrier may be used in insulated glazing units to allow connection of electrical elements within laminated panes using means suitable for connection to electrical elements within insulated glazing cavities, such as spacer frame sections with integrated connections. In this manner, electrical elements may be provided in laminated form, but simply connected to electrical inputs within an insulated glazing. In some cases this may allow the full cavity width to be preserved, because the electrical element is not within the cavity. A benefit of preserving the full cavity width is that the IGU is suitable for combination with conventional cavity fixtures, such as blinds.

Also, such an electrical carrier allows electrical communication between an electrical element within the laminated pane and the cavity of an insulated glazing.

As defined herein, a first feature described as adhered indirectly to a second feature is in contact with a layer upon the second feature, with only an adhesive substance such as a glue or tape between them where required. The thickness of the adhesive substance such as the glue or tape is preferably minimised to ensure a strong and secure adhesion. Such a layer upon the second feature may for example comprise, an organic or inorganic coating, a plastic sheet, or a metal foil.

Therefore, preferably the electrical carrier is adhered directly or indirectly to the first major face with an adhesive, preferably a glue or tape. Glues and tapes, in particular double sided tapes, are economic and widely available. Alternatively or in addition, tapes which pass over the carrier, such that it is adhered directly to the first major face without that tape between the carrier and the first major face, may be used.

Preferred glues include hot melt adhesives, polyurethane adhesives, and/or methyl methacrylate adhesives.

However, preferably the adhesive is not a polyisobutylene type adhesive suitable for use in a secondary sealant of an insulated glazing unit. The inventors have discovered the polyisobutylene type adhesives that are suitable for use in a secondary sealant of an insulated glazing unit are difficult to apply in a manner that allows a minimal thickness of the adhesive to be achieved, while also preventing squeeze out and smearing.

Preferably, the thickness of the adhesive, in particular a glue or tape, is minimised, to prevent a bulky appearance, excess squeeze out, and to reduce vulnerability to forces applied across the plane of the adhesive. As such, preferably the thickness of the adhesive, in particular a glue or tape, is less than 5 mm, more preferably less than 1 mm, and even more preferably less than 0.5 mm. The thickness of the adhesive is measured between electrical carrier and feature the electrical carrier is adhered to, be it the first surface or an intermediate layer.

Preferably, the first sheet of glazing material comprises glass and/or the second sheet of glazing material comprises glass. Glass is a widely available and useful glazing material. Soda-lime glass may be particularly preferred, due to low cost. Alternatively, alumina-silicate, boro-silicate and aluminium boro-silicate glasses may be used. Sheets of glazing material of a wide range of thicknesses may be employed in the present invention, preferably the sheets of glazing material have a thickness from 0.1 to 25 mm. However, considering weight and rigidity it may be preferred that sheets of glazing material, and in particular glass, are of a thickness from 3 mm to 8 mm.

In some embodiments, the edge face of the first sheet of glazing material is offset from the edge face of the second sheet of glazing material, such that the electrical carrier does not protrude beyond the edge face of the second sheet of glazing material. Such an arrangement is beneficial, as delicate electrical carriers may be protected from snagging, rubbing and other damaging interactions.

Alternatively or additionally, an edge of the laminated pane associated with the electrical carrier may be provided with a capping layer to prevent damage. Such a capping layer may comprise, for example, silicone, polyisobutylene, polysulfide, or hot melt.

Adhesive layers may be selected from the group comprising ethylene vinyl acetate (EVA), polyisobutylene, polyvinyl butyral (PVB), polyurethane (PU), cyclo olefin polymers (COP), ultraviolet activates adhesives. However, preferably, the adhesive layer comprises polyvinyl butyral. Polyvinyl butyral (PVB) is a widely available adhesive layer material. The type of adhesive layer is not particularly limited, but where acoustic, bullet or intruder resistance is required adhesive layers suitable for such applications may be used.

In some embodiments, the adhesive layer comprises two or more sublayers. In this manner sublayers of different sizes may be used to allow for improved incorporation of the electrical element and/or electrical carrier, for example so called “picture frame” arrangements may be used. In addition, adhesive layers comprising a sublayer of non-adhesive material may be used, such as polyethylene terephthalate. However, where a sublayer of non-adhesive material is used it is desirable that the sublayer of non-adhesive material is between two sublayers comprising adhesive material, preferably polyvinyl butyral, to allow secure adhesion.

In some embodiments the electrical element comprises a busbar or contact. The type of busbar or contact is not particularly limited, but may be associated with functional elements which are within the laminated pane. The busbar or contact may be electrically connected to functional elements using soldered connections, ultrasonic welds, conductive adhesives and the like.

In some embodiments the electrical element may comprise a functional element, and the electrical carrier may be directly connected to a functional element. In this case, the electrical carrier may function as a busbar for the functional element.

Such functional elements may comprise heating coatings, displays, LEDs, transducers, speakers, sensors, variable transmission elements, photovoltaic elements and the like. In particular: displays may include LCD and OLED displays for example; Variable transmission elements may include LCD, electrochromic, and suspended particle elements, for example; and photovoltaic elements may comprise silicon including, cadmium including, or dye including cells, for example.

Preferably, the electrical carrier is insulated in an area associated with the edge face of the first sheet of glazing material, and/or in an area associated with the periphery of the first face, and/or in an area associated with the periphery of the second face.

Insulated sections of the electrical carrier may prevent the electrification of a frame of the laminated pane, or the electrification of an insulated glazing frame and/or spacer frame when the laminated pane is incorporated in an insulated glazing.

As such, preferably the electrical carrier is insulated in an area associated with the edge face of the first sheet of glazing material, and in an area associated with the periphery of the first face, and in an area associated with the periphery of the second face.

In some embodiments, the electrical carrier is adapted to be suitable for contact with an electrical connector within a cavity of an insulated glazing. Alternatively or in addition, the electrical carrier is adapted to be suitable for contact with an electrical connector associated with a spacer frame of an insulated glazing.

An electrical carrier may be adapted to be suitable for contact with an electrical connector in that it is not insulated in a region intended for connection. Alternatively, sockets and plugs suitable for mating with an electrical connector may be added to the electrical carrier in a region intended for connection.

Preferably, the electrical carrier is adhered directly or indirectly to the edge face of the first sheet of glazing material. An electrical carrier that is adhered directly or indirectly to the edge face of the first sheet of glazing material is less likely to be damaged during production, transport and installation of the laminated pane.

Preferably, the electrical carrier is permanently adhered directly or indirectly to the first face and/or the second face and/or the edge face of the first sheet of glazing material. Permanently adhered is defined herein as being adhered such that the electrical carrier cannot be removed without the use of solvents, and/or cannot be removed reversibly such that the electrical carrier may be easily re-adhered, and/or cannot be removed without damage to the electrical carrier, electrical element or laminated pane.

Preferably, the electrical carrier is permanently adhered directly or indirectly to the first face and the second face, more preferably the electrical carrier is permanently adhered directly or indirectly to the first face and the second face and the edge face of the first sheet of glazing material.

Most preferably, where the electrical element is on the second face, the electrical carrier is permanently adhered directly to the first major face, the second major face, and the edge face of the first sheet of glazing material. Such an arrangement allows for the most secure physical connection between the electrical carrier and the laminated pane.

Preferably, the electrical carrier is in direct electrical communication with the electrical element. Such direct electrical communication may be achieved by soldering, ultrasonic welds, conductive adhesives and the like.

The material of the electrical carrier is not particularly limited, except that it should be able to conduct electricity, and should be sufficiently flexible to be manipulated such that the first end is adhered directly or indirectly to the first major face and the second end is in electrical communication with the electrical element.

In some embodiments the electrical carrier may comprise a foil, preferably a metal foil. This is of particular benefit when the electrical element is a busbar for a heating coating, or a heating coating, and the electrical carrier is required to carry a large amount of energy to drive the heating coating.

Alternatively, the electrical carrier may comprise a flexible circuit board, also known as flexible printed circuit (FPC). Such flexible circuit boards may comprise polyimide foil, polyimide-fluoropolymer composite foil, or other flexible polymeric materials. The flexible circuit board comprises one or more conductive traces suitable for carrying electrical energy and/or data, and such traces may comprise copper, silver, and/or gold.

Alternatively, the electrical carrier may be a braided flat cable, ribbon cable, or a flat flex cable. These may be flat laminated cables (FLC) or flat extruded cables (FEC).

In some embodiments, the electrical carrier is prefabricated with the electrical element, such that the electrical carrier is formed as an integral part of the electrical element.

Preferably, the electrical carrier is from 0.1 to 2 mm in thickness. Such a thickness allows the electrical carrier to be used with adhesive layers of conventional thicknesses.

In some embodiments that the electrical carrier is from 0.3 to 0.5 mm in thickness, and preferably from 0.35 to 0.40 mm in thickness, more preferably 0.38 mm in thickness. Such a thickness allows the electrical carrier to be used with adhesive layers or sublayers of conventional thickness and reduces the risk of bubbles forming during lamination.

Alternatively, in some embodiments the electrical carrier is from 0.6 to 0.9 mm in thickness, and preferably 0.73 to 0.79 mm in thickness, more preferably 0.76 mm in thickness. Such a thickness allows the electrical carrier to be used with adhesive layers or sublayers of conventional thickness and reduces the risk of bubbles forming during lamination.

Alternatively, in some embodiments the electrical carrier is from 1.0 to 1.3 mm in thickness, and preferably 1.10 to 1.20 mm in thickness, more preferably 1.14 mm in thickness. Such a thickness allows the electrical carrier to be used with adhesive layers or sublayers of conventional thickness and reduces the risk of bubbles forming during lamination.

Alternatively, in some embodiments the electrical carrier is from 1.4 to 1.6 mm in thickness, and preferably 1.45 to 1.58 mm in thickness, more preferably 1.52 mm in thickness. Such a thickness allows the electrical carrier to be used with adhesive layers or sublayers of conventional thickness and reduces the risk of bubbles forming during lamination.

In some cases the electrical carrier may be adapted for connecting to multiple electrical elements. Such adaption may be in the form of three or more ends or connecting portions suitable for connection with three of more electrical elements.

In some embodiments the third major surface may be provided with an second electrical element. In such cases, it is beneficial to use an electrical carrier which is adapted for electrical connection, preferably direct electrical connection, to the first electrical element and the second electrical element.

According to a second aspect of the present invention there is provided a method of manufacturing a laminated pane according to any preceding claim, comprising providing an arrangement comprising:
a first sheet of glazing material comprising a first major face, a second major face and an edge face;
a second sheet of glazing material comprising a third major face, a fourth face and an edge face;
an adhesive layer between the second face and the third face;
an electrical element between the first sheet of glazing material and the second sheet of glazing material; and
an electrical carrier in electrical communication, preferably direct electrical communication, with the electrical element, and
   laminating the first and second sheets of glazing material together with the adhesive sheet, wherein
   a first end of the electrical carrier is adhered directly or indirectly to the first major face before or after the step of laminating the first and second sheets of glazing material.

Such a method is an efficient process for the production of the inventive laminated pane.

The skilled person will appreciate that additional glass layers, adhesive layers, and functional elements may be provided within the laminate.

The adhesive layer may comprise an adhesive layer assembly. Where an adhesive layer assembly is used, this may be made up of multiple adhesive sublayers, which may are preferably arranged to minimise the occurrence of bubbles following the laminating step. As such, preferably, the adhesive layer or adhesive layer assembly comprises a void suitable for the electrical carrier prior to lamination.

Preferably the adhesive layer assembly comprises at least two sets of adhesive sublayers, wherein a first set of one or more sublayers are arranged in direct contact with the first sheet of glazing material and not over the electrical carrier or electrical element, or a functional element, a second set of one or more sublayers are arranged over the first set of one or more sublayers and over and in direct contact with the over the electrical carrier or electrical element, or a functional element.

In some embodiments, the method comprises a further step of incorporating the laminated pane in an insulated glazing after the step of adhering the first end directly or indirectly to the first major face.

The step of laminating the first and second sheets of glazing material together with the adhesive sheet may be accomplished using an autoclave or a hot-press type laminator.

According to a third aspect of the present invention there is provided an insulated glazing suitable for installation in a building, façade or architectural barrier, comprising a laminated pane according to the first aspect, further comprising:
a second glazing pane in a spaced apart face-to-face arrangement with the laminated pane and with a cavity therebetween, wherein the first face is orientated toward the cavity;
a spacer frame between the second glazing pane and the laminated pane suitable for maintaining the cavity; and
an electrical connector suitable for connection to a power and/or data source outside the insulated glazing, wherein the electrical connector contacts the first end of the electrical carrier.

The insulated glazing of this aspect of the present invention may be formed economically, and allows the use of electrical connection methods which are readily available for insulated glazing units.

Preferably the second glazing pane comprises a sheet of glazing material comprising glass. Glass is a widely available and useful glazing material. Soda-lime glass may be particularly preferred, due to low cost. Alternatively, alumina-silicate, boro-silicate and aluminium boro-silicate glasses may be used. Sheets of glazing material of a wide range of thicknesses may be employed in the present invention, preferably the sheets of glazing material have a thickness from 0.1 to 25 mm. However, considering weight and rigidity it may be preferred that sheets of glazing material, and in particular glass, are of a thickness from 3 mm to 6 mm. The second glazing pane may be a laminated pane.

The second glazing pane may comprise coatings, such as low-emissivity, self-cleaning, and infra-red radiation reflection coatings, as known to the skilled person.

Preferably the cavity comprises argon, krypton, dry air or another gas, depending on the desired thermal performance of the insulated glazing. Alternatively, the cavity may comprise a vacuum.

A wide variety of spacer frame bodies known to the person skilled in the art can be used since the solution according to the invention is compatible with any spacers.

In some embodiments the spacer frame may comprise a rigid spacer frame. A rigid spacer frame in general will have enough rigidity to be preassembled prior to application and applied against one pane of the insulating glass before assembly. Preferably the rigid spacer frame comprises a hollow rigid spacer or a U-channel rigid spacer, which may be fully metallic or may comprise polymeric parts.

In some embodiments the spacer comprises a metallic body. This has the advantage that metallic spacers are gas-tight, and no barrier films are needed to seal the outer surface of the spacer. The metallic main body is preferably made of aluminium or stainless steel, particularly preferably aluminium.

Alternatively, the spacer includes a polymeric frame body. This is advantageous since the thermal conductivity of plastics is significantly lower than the thermal conductivity of metals. The polymeric main body preferably contains polyethylene (PE), polycarbonates (PC), polypropylene (PP), polystyrene, polybutadiene, polynitriles, polyesters, polyurethanes, polymethyl methacrylates, polyacrylates, polyamides, polyethylene terephthalate (PET), polybutylene terephthalate (PBT), preferably acrylonitrile butadiene styrene (ABS), acrylonitrile styrene acrylester (ASA), acrylonitrile butadiene styrene/polycarbonate (ABS/PC), styrene acrylonitrile (SAN), PET/PC, PBT/PC, and/or copolymers or mixtures thereof. Particularly good results are achieved with these materials.

Rigid spacers that comprise polymeric parts may contribute to decreased heat loss through the glazing. A suitable spacer with a polymeric main body is disclosed, for example, in WO 2013/104507 A1.

In general, a rigid spacer frame will comprise joint pieces for connecting rigid spacers together to form the frame. A joint piece that connects rigid spacers to form a corner is known as a corner key.

In alternative embodiments, the spacer frame may comprise a flexible spacer frame. Preferably, a flexible spacer frame comprises a hot applied flexible spacer or a pre-fabricated flexible spacer, which are polymeric. A hot applied flexible spacer is commonly extruded directly onto a glass pane at elevated temperature before assembly, while a prefabricated flexible spacer is extruded onto an intermediate surface at ambient or elevated temperature, then applied as a whole frame to the glass pane before assembly. An extruded thermoplastic spacer is disclosed in WO 2015197491 A1.

Often the spacer frame will comprise desiccant. Hollow rigid spacers and U-channel rigid spacers may include a powder desiccant within the hollow or channel, while flexible spacers may include desiccant beads and the like within the spacer material.

In some embodiments, the spacer is a double spacer that can accommodate at least one additional pane in a groove. Such spacers are known from WO 2014/198431 A1, among others.

The electrical connector is not particularly limited, but preferably is selected from readily available connectors usable for connecting to electrical elements or functional elements upon an insulated glazing pane surface orientated towards the cavity. Examples of such connectors are disclosed for example in WO 2019141700 A1, WO 2019141749 A1.

In some embodiments the electrical connector contacts the electrical carrier within the cavity. This teaching will be a surprise to the skilled person, as this embodiment necessitates that the electrical carrier breaches the hermetic seal formed by the spacer. However, this allows a secure connection to be made with the connector, and allows the use of connectors conventionally used to contact electrical elements within the insulated glazing cavity.

In some embodiments the electrical connector contacts the electrical carrier with a connector integrated into a spacer frame member, such as a spacer frame member comprising an electrical connector. Such a contact may be made within the cavity and/or within the area defined by the hermetic seal of the spacer frame. This allows a secure connection to be made with the connector, and allows the use of connectors conventionally used to contact electrical elements within the insulated glazing cavity.

Preferably, the insulated glazing further comprises a secondary sealant, preferably a polyisobutylene secondary sealant, which is suitable for forming a hermetic seal. Such seals are well known to the skilled person.

Preferably, the insulated glazing conforms to EN1279 standards.

According to a fourth aspect of the present invention, there is provided an architectural barrier, preferably a divider or an acoustic barrier, comprising a laminated pane according to the first aspect of the present invention.

According to a fifth aspect of the present invention there is provided a façade or frameless glazing assembly comprising a laminated pane according to the first aspect of the present invention, or an insulated glazing according to the third aspect of the present invention.

The skilled person will appreciate that optional features of aspects 1, 2, 3, 4 and/or 5 of the present invention may be combined with one another and with other aspects as is required by the needs of the skilled person.

The invention will now be described according to figures, in which:

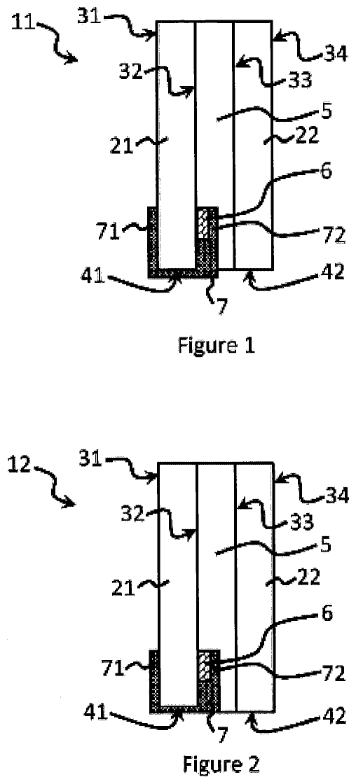

FIG. 1 depicts a laminated pane suitable for installation in a building, façade or architectural barrier;

FIG. 2 depicts an alternative laminated pane suitable for installation in a building, façade or architectural barrier;

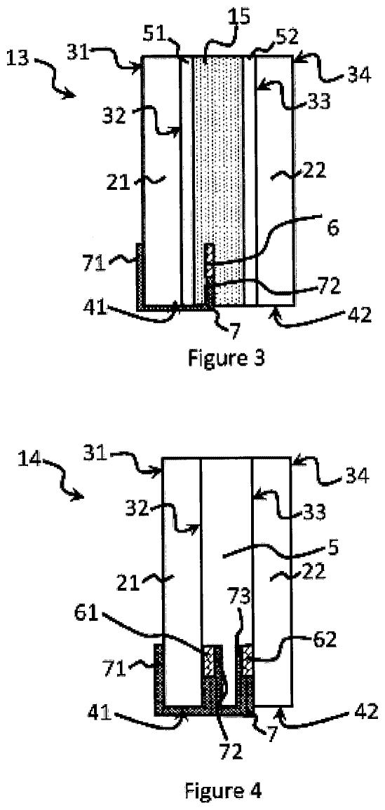

FIG. 3 depicts an alternative laminated pane suitable for installation in a building, façade or architectural barrier;

FIG. 4 depicts an alternative laminated pane suitable for installation in a building, façade or architectural barrier;

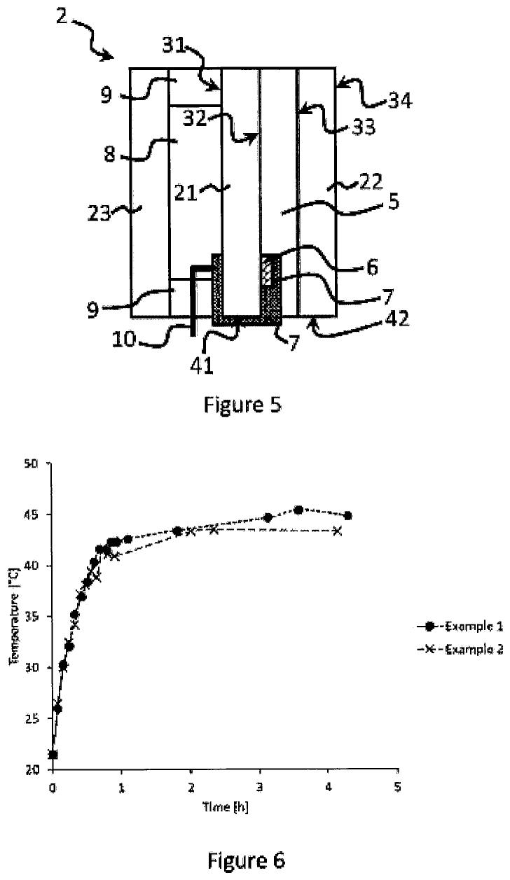

FIG. 5 depicts an insulated glazing suitable for installation in a building, façade or architectural barrier, comprising a laminated pane as described in FIG. 1; and

FIG. 6 depicts a graph of laminated pane temperature against heating time for two laminated panes according to the present invention.

FIG. 1 depicts a laminated pane 11 suitable for installation in a building, façade or architectural barrier, comprising: a first sheet of glazing material 21 comprising a first major face 31, a second major face 32 and an edge face 41, and a second sheet of glazing material 22 comprising a third major face 33, a fourth face 34 and an edge face 42. An adhesive layer 5 is between the second face 32 and the third face 33 and adheres the first sheet of glazing material 21 to the second sheet of glazing material 22.

An electrical element 6 is between the first sheet of glazing material 21 and the second sheet of glazing material 22. In this embodiment the electrical element 6 is a busbar, which is in direct electrical connection with a heating coating (not shown) upon the second major face 32. The laminated pane comprises an electrical carrier 7 comprising a first end 71, which in this embodiment is adhered directly to the first major face 31, and a second end 72, which in in this embodiment is in direct electrical communication with the electrical element 6.

FIG. 2 depicts an alternative laminated pane 12 suitable for installation in a building, façade or architectural barrier. Like numbering is used for like features with FIG. 1. In this embodiment, an offset can be seen between the edge face 41 of the first sheet of glazing material 21 and the edge face 42 of the second sheet of glazing material 22. This offset is at least as large as the thickness of the electrical carrier 7. This reduces the likelihood that the electrical carrier will be damaged. Alternatively or additionally, the edge of the laminated pane associated with the electrical carrier may be provided with a capping layer to prevent damage. Such a capping layer may comprise, for example, silicone, polyisobuylene, polysulfide, or hot melt.

FIG. 3 depicts an alternative laminated pane 13 suitable for installation in a building, façade or architectural barrier. Like numbering is used for like features with FIG. 1. In this embodiment a functional element 15 is between the first 21 and second 22 sheets of glazing material. The functional element 15 may be, for example, a LCD, an OLED, an electrochromic unit, a suspended particle unit, among others. Two adhesive layers 51 and 52 are used to adhere the functional element to the first 21 and second 22 sheets of glazing material. In this embodiment the electrical element 6 is within the functional element 15, and may take the form of a connector, busbar, or other electrical feature for operating the functional element. In this embodiment the electrical carrier 7 is in direct electrical connection with the electrical element 6, and may be an integrated flexible cable, which is supplied with the functional element.

In this embodiment the edge face 41 of the first sheet of glazing material 21 may be offset from the edge face 42 of the second sheet of glazing material 22 as in FIG. 2. This reduces the likelihood that the electrical carrier will be damaged. Alternatively or additionally, the edge of the laminated pane associated with the electrical carrier may be provided with a capping layer to prevent damage. Such a capping layer may comprise, for example, silicone, polyisobuylene, polysulfide, or hot melt.

FIG. 4 depicts an alternative laminated pane 14 suitable for installation in a building, façade or architectural barrier. Like numbering is used for like features with FIG. 1. This embodiment comprises a first electrical element 61 and a second electrical element 62, wherein the first electrical element is adjacent to the second surface 32 and the second electrical element 62 is adjacent to the third surface 33.

In this embodiment the first and second electrical elements 61, 62 are busbars, which are in direct electrical connection with heating coatings (not shown) upon the second and third major faces 32, 33.

The laminated pane comprises an electrical carrier 7 comprising a first end 71, which in this embodiment is adhered directly to the first major face 31, a second end 72, which in in this embodiment is in direct electrical communication with the first electrical element 61, and a third end 73, which in this embodiment is in direct electrical communication with the second electrical element 62.

It will be appreciated that features of other embodiments may be combined, for example an offset may be implemented between the edge face 41 of the first sheet of glazing material 21 and the edge face 42 of the second sheet of glazing material 22 as in FIG. 2. Alternatively or additionally, the edge of the laminated pane associated with the electrical carrier may be provided with a capping layer to prevent damage. Such a capping layer may comprise, for example, silicone, polyisobutylene, polysulfide, polyurethane, or hot melt.

FIG. 5 depicts an insulated glazing 2 suitable for installation in a building, façade or architectural barrier, comprising a laminated pane as described in FIG. 1, like numbering is used for like features. The insulated glazing 2 further comprises a second pane 23 in a spaced apart face-to-face arrangement with the first sheet of glazing material 21 and with a cavity 8 therebetween. A spacer frame 9 is between the second pane 23 and the first sheet of glazing material 21 and is suitable for maintaining the cavity. The insulated glazing comprises an electrical connector 10 suitable for connection to a power and/or data source outside the insulated glazing, wherein the electrical connector 10 contacts the electrical carrier 7 in an area associated with the first surface 31. In this embodiment, wherein the electrical connector 10 contacts the electrical carrier 7 within the boundary of the spacer frame. The skilled person will appreciate that further insulated glazing embodiments may incorporate laminated panes as depicted in FIGS. 1, 2, 3 and/or 4 in addition or instead of the laminated pane as described in FIG. 1.

The invention will now be described by reference to non-limiting example embodiments.

A first example laminated pane was prepared comprising a first sheet of soda-lime silica glass of 4 mm thickness comprising a layer transparent conductive oxide (fluorine doped tin oxide, TEC 15, available from NSG) and two conductive CuSn tape busbars. Two commercially available electrical carriers were applied to the busbars and a second sheet of soda-lime silica glass of 4 mm thickness (Optifloat, available from NSG) laminated to the first sheet with a PVB interlayer of 0.76 mm thickness. Lamination was accomplished using a commercially available lamination system (LAMIPRESS VARIO) without the use of an autoclave. After lamination the free ends of the electrical carriers were adhered to an outer major face of the laminated pane.

A second example laminated pane was prepared comprising a first sheet of soda-lime silica glass of 4 mm thickness comprising a layer transparent conductive oxide (fluorine doped tin oxide, TEC 15, available from NSG) and two conductive CuSn tape busbars. Two commercially available electrical carriers were applied to the busbars and a second sheet of soda-lime silica glass of 4 mm thickness comprising a layer of transparent conductive oxide (fluorine doped tin oxide, TEC 15, available from NSG) was laminated to the first sheet with a PVB interlayer of 0.76 mm thickness. The coatings were orientated to be adjacent to the PVB interlayer. Lamination was accomplished using a commercially available lamination system (LAMIPRESS VARIO) without the use of an autoclave. After lamination the free ends of the electrical carriers were adhered to an outer major face of the laminated pane.

The electrical properties of the laminated panes were tested by connecting the free ends of the electrical carriers to a 24 V DC power supply resulting in a current of 2.5 to 2.6 amps. The first example laminated pane was observed to reach a temperature over 40° C. within less than 37 minutes and an equilibrium temperature of 44-45° C. within less than 3 hours. The second example laminated pane was observed to reach a temperature of over 40° C. within less than 44 minutes, and after 2 hours the sample reached an equilibrium temperature of 43° C. As shown by FIG. 6, both samples warm up rapidly and then reach an equilibrium temperature which is suitable for providing radiative heat to a building interior or glazing cavity.

Observation with an infra-red camera of the laminated panes during resistive heating indicated that they were heated uniformly between the busbars with no hotspots which might cause delamination or damage to the panes. Both example laminated panes showed acceptable optical properties.

While the example laminated panes are heatable panes, other features may be incorporated as described elsewhere herein.

The laminated pane and insulated glazing comprising the laminated pane allow connection to be made to an electrical element within the laminated pane in a secure, robust and simple manner.

1-25. (canceled)

26. A laminated pane suitable for installation in a building, façade or architectural barrier, comprising:
a first sheet of glazing material comprising a first major face, a second major face and an edge face;
a second sheet of glazing material comprising a third major face, a fourth face and an edge face;
an adhesive layer between the second face and the third face;
an electrical element between the first sheet of glazing material and the second sheet of glazing material; and
an electrical carrier adhered directly or indirectly to the first major face and in electrical communication, optionally direct electrical communication, with the electrical element.

27. The laminated pane according to claim 1, wherein the electrical carrier is adhered directly or indirectly to the first major face with an adhesive, and optionally the adhesive comprises a glue or tape.

28. The laminated pane according to claim 26, wherein the thickness of the adhesive is less than 5 mm, is optionally less than 1 mm or less than 0.5 mm.

29. The laminated pane according to claim 26, wherein the first sheet of glazing material comprises glass and/or the second sheet of glazing material comprises glass.

30. The laminated pane according to claim 26, wherein the edge face of the first sheet of glazing material is offset from the edge face of the second sheet of glazing material, such that the electrical carrier does not protrude beyond the edge face of the second sheet of glazing material.

31. A laminated pane according to claim 26, wherein an edge of the laminated pane associated with the electrical carrier may be provided with a capping layer to prevent damage, preferably the capping layer comprises silicone, polyisobutylene, polysulfide, polyurethane, or hot melt, most preferably polyisobutylene.

32. The laminated pane according to claim 26, wherein the adhesive layer comprises polyvinyl butyral.

33. The laminated pane according to claim 26, wherein the adhesive layer comprises two or more sublayers, and optionally the two or more sublayers comprise polyvinyl butyral.

34. The laminated pane according to claim 26, wherein the electrical element comprises a busbar, a contact, or a functional element, and optionally comprises a busbar adjacent to the second major face.

35. The laminated pane according to claim 26, wherein the electrical carrier is insulated in an area associated with the edge face of the first sheet of glazing material, and/or in an area associated with the periphery of the first face, and/or in an area associated with the periphery of the second face.

36. The laminated pane according to claim 26, wherein the electrical carrier is adapted to be suitable for contact with an electrical connector within a cavity of an insulated glazing and/or wherein the electrical carrier is adapted to be suitable for contact with an electrical connector associated with a spacer frame of an insulated glazing.

37. The laminated pane according to claim 26, wherein the electrical carrier is adhered directly or indirectly to the edge face of the first sheet of glazing material.

38. The laminated pane according to claim 26, wherein the electrical carrier is permanently adhered directly or indirectly to the first face and/or the second face and/or the edge face of the first sheet of glazing material, and optionally the electrical carrier is permanently adhered directly or indirectly to the first face and the second face and the edge face of the first sheet of glazing material.

39. The laminated pane according to claim 26, wherein the electrical carrier comprises a metal foil, flexible circuit board, braided flat cable, ribbon cable, or flat flex cable.

40. The laminated pane according to claim 26, further comprising a second electrical element between the first sheet of glazing material and the second sheet of glazing material, wherein the electrical carrier is in electrical communication with the second electrical element, and optionally wherein the second electrical element is a busbar adjacent to the second major face.

41. A method of manufacturing a laminated pane according to claim 26, comprising
providing an arrangement comprising:
a first sheet of glazing material comprising a first major face, a second major face and an edge face;
a second sheet of glazing material comprising a third major face, a fourth face and an edge face;
an adhesive layer between the second face and the third face;
an electrical element between the first sheet of glazing material and the second sheet of glazing material; and
an electrical carrier in electrical communication, optionally direct electrical communication, with the electrical element, and
laminating the first and second sheets of glazing material together with the adhesive sheet,
wherein a first end of the electrical carrier is adhered directly or indirectly to the first major face before or after the step of laminating the first and second sheets of glazing material.

42. An insulated glazing suitable for installation in a building, façade or architectural barrier, comprising a laminated pane according to claim 26, further comprising:
a second glazing pane in a spaced apart face-to-face arrangement with the laminated pane and with a cavity therebetween, wherein the first face is orientated toward the cavity;
a spacer frame between the second glazing pane and the laminated pane suitable for maintaining the cavity; and
an electrical connector suitable for connection to a power and/or data source outside the insulated glazing, wherein the electrical connector contacts the first end of the electrical carrier.

43. The insulated glazing according to claim 42, wherein the second glazing pane comprises glass, optionally soda-lime silica glass of thickness from 3 mm to 6 mm.

44. The insulated glazing according to claim 42, wherein the spacer comprises a polymeric or metallic main body including at least one hollow chamber or channel, or a polymeric flexible spacer frame.

45. The insulated glazing according to claim 42, wherein the electrical carrier contacts the electrical connector within the cavity, and/or wherein the electrical carrier contacts the electrical connector within the area defined by a hermetic seal of the spacer frame, and/or wherein a spacer frame member comprises the electrical connector.
